(19) United States
(12) Patent Application Publication
(10) Pub. No.: US 2014/0149463 A1
(43) Pub. Date: May 29, 2014

(54) METHOD, APPARATUS, SYSTEM AND COMPUTER PROGRAM PRODUCT FOR MANAGING DATA IN DATABASE

(71) Applicant: Juha Uola, Tampere (FI)

(72) Inventor: Juha Uola, Tampere (FI)

(73) Assignee: NOKIA CORPORATION, Espoo (FI)

(21) Appl. No.: 13/979,067

(22) PCT Filed: Dec. 29, 2010
(86) PCT No.: PCT/FI2010/051095

§ 371 Date: Oct. 1, 2013

(51) Int. Cl. G06F 17/30

(52) U.S. Cl. CPC G06F 17/30607
USPC 707/792

(57) ABSTRACT

There is disclosed a method, apparatuses and computer program products for managing a database. In the method resources to be usable by entities are stored to the database. The resources comprise one or more fields. At least one resource is provided with a first control data, such as an owner field. Said first control data is used to determine whether the resource is related to an entity. If said first control data indicates that the resource is related to said entity, the resource is left in the database. The first control data may further be used to determine whether at least one field of said one or more fields of the resource is modifiable by an entity.

Method, apparatus, system and computer program product for managing data in database

### TECHNICAL FIELD

This invention relates to a method, an apparatus, and a computer program product for managing data in a database.

### BACKGROUND INFORMATION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The technical field relates to semantic desktop and managing a personal database that is accessed by many applications. The database may be a resource description framework (RDF) store that stores data and metadata, such as contacts, calendar info or e-mail metadata, but it can contain any kind of user's personal data or data that is fetched from a network. The RDF data model is similar to classic conceptual modelling approaches such as Entity-Relationship or Class diagrams, as it is based upon the idea of making statements about resources (in particular Web resources) in the form of subject-predicate-object expressions. These expressions are known as triples in RDF terminology. The subject S denotes the resource R, and the predicate P denotes traits or aspects of the resource R and expresses a relationship between the subject S and the object O (see FIG. 1). For example, one way to represent the notion “The sky has the colour blue” in RDF is as the triple: a subject denoting “the sky”, a predicate denoting “has the colour”, and an object denoting “blue”. RDF is an abstract model with several serialization formats (i.e. file formats), and so the particular way in which a resource or triple is encoded may vary from format to format.

The data in the RDF store is in the form of labelled, directed multi-graph and it may follow predefined ontology, such as the networked environment for personalized, ontology-based management of unified knowledge (NEPOMUK) ontology. Even though RDF data model is based on triples, RDF data may often be persisted in a relational database, such as SPARQL Protocol and RDF Query Language database.

Each resource in RDF data model is identified by a unique internationalized resource identifier IRI (http://www.ietf.org/rfc/rfc3987.txt). An IRI is a sequence of characters e.g. from the universal character set (Unicode/ISO 10646). A mapping from IRIs to uniform resource identifiers (URIs) may be defined, which means that IRIs can be used instead of URIs, where appropriate, to identify resources. Predicate value of the resource may be an empty blank node, literal, string or IRI. If predicate value is IRI, it is referred as a pointer or a reference to an object resource in this application. Each resource also has a type that is defined in the ontology. Ontology may be pre-defined or dynamically introduced, but the time of ontology definition is not relevant in this context.

There are some problems in the above described system. For example, several applications may share a common database that can get easily corrupted, even though the applications share a common ontology. The problem relates to writing and maintaining the database. In the existing systems it may be problematic to determine how applications are supposed to interoperate with the metadata in the database and how to maintain data from various applications in a single database. The system may also not be able to determine how is the data tied to application life cycle or when shall the data of an application be removed. Applications may not know whether a certain piece of data belongs to it and not to some other application.

For example, an application A creates objects of type “Person” and “Location” to the database. The object “Person” has a “name” predicate and the object “Location” has a “coordinates” predicate. Application A makes sure that each Person object it creates points to a Location object, which specifies a person's current location. A list of persons and their locations may be fetched e.g. from a network service, such as Google Maps. Application B also creates objects of type Person based on information in a local address book. Application B is able to add phone number to each Person it creates. If a Person with a certain name already exists, application B merely adds the phone number to already existing Person. When applications are using a common ontology and database, the situation is as shown in FIG. 2. A problem arises when the application A is to be removed, e.g. due to the fact that the web service providing location data is no longer active (see FIG. 3). It may be necessary to clean the database from invalid data so that it does not get cluttered as applications are constantly added and removed. One problem is that the system may not be able to determine whether those Person objects that have been edited by both applications A and B can be removed or should all Location objects be removed or should Location objects that have a valid Person object pointing to it be spared. This is a single example of a generic problem for which a generic solution for the whole database and all applications using it would be beneficial to find out.

The above described problems may not exist in systems in which each application has its own database, for example in SQL (structured query language). In SPARQL, data of different applications share one table and the query language allows selecting data of all applications at once. This feature makes SPARQL convenient for cross-application data integration, but is problematic in terms of data privacy, for example.

The most common mechanism to solve the problem currently is to ensure that all applications come from the same vendor and know each other, which may guarantee interoperability. The invention provides a solution to the problem when applications come from different vendors and are not aware of each other's operation.

In the following some further background information is shortly provided. Gnowsis is a semantic desktop system that gathers meta-data from applications on a device and from semantic web. The architecture is typical semantic desktop architecture in that applications store their data normally and are typically unaware of Gnowsis. Gnowsis allows defining Aperture data crawlers that are able to pull meta-data from application-specific data stores. This means that data crawlers use Aperture framework to import the data into common data store (Personal Information Model, PIMO); a new data crawler needs to be defined for each new application; data is stored twice: in application-specific storage with application-specific data format and in Gnowsis repository that follows common ontology; there can be a delay in meta-data appearing to Gnowsis repository; and data crawlers require CPU resources. On mobile platform CPU resources may be more limited than what is available on a desktop platform.

In the ontology-based, cross-application context management (croco) system context data is stored to RDF store by several context providers. Consistency checking is performed for the RDF store by a consistency manager. Several consistency enforcers can be registered to ensure consistency of certain aspect (e.g. data type or cardinality). The consistency enforcers are activated every time new data is added to the RDF store. In addition, context providers are assigned a confidence and reputation value, which allows defining “quality” for a context value. However, CroCo does not define how the data from different context providers can be managed; only that it remains consistent with the ontology. In addition, CroCo is targeted purely for context data, not for generic RDF data. CroCo uses a separate database for inferred context data that could potentially overwrite existing primary context data.

### Summary of Some Example Embodiments

Some example embodiments of the present invention avoid many of known problems by using central data storage that is common to all applications. Data is stored only in one place. Applications are aware of the common data storage where applications may store meta-data. Unlike on desktop systems, applications may be expected to use common data storage directly on some mobile platforms.

In some example embodiments there is provided a RDF store management system based on identifying applications that use the RDF store. Certain resources in the RDF store are tied to certain application and managing the life-cycle of the resources according to the application life-cycle is enabled.

This means, among other things, that when an application is uninstalled, the data that was input to the RDF store by the application can be removed.

The mechanism of some example embodiments are useful e.g. in the following situation. Applications have use cases where they can use pre-existing resources in an RDF store. For example, if a Contact resource with name “John Doe” exists and an application is creating a Contact with exactly that name, the application may determine that the creation of a new resource is not necessary and the existing resource can be used instead.

Some example embodiments of the invention include a collection algorithm for unused RDF store resources. This may mean that each resource has additional meta-data, which is updated, when application creates or modifies a resource. This additional meta-data allows determining which applications are using or depending on a particular resource. FIGS. 4a-4c depict an example of a simple case. FIG. 4a depicts an example when an application A creates resources, FIG. 4b depicts an example when an application B creates and modifies resources, and FIG. 4c depicts an example when the application A is removed. When application A is removed, all resources for which the application A is the sole owner can be removed. The underlying RDF framework may take care of that no dangling predicate references are left behind, when an object resource is removed. The ownership of the application A to any resource is removed as well. It should be noted that the data created by the application A may still be left inside resources that are co-owned by other applications. This data cannot be removed, as it could be critical for other applications that have opted to use the resource created by the application A to their own purposes.

Some example embodiments may also include using the collection algorithm when a user of a device wishes to remove resources which have been created when the user has used some application or applications of the device. Hence, the collection algorithm may search resources relating to the user so that such resources can be removed.

In some embodiments the database may exist in another device which may be accessible by the device via a network, e.g. via the internet. For example, the database may exist in a network server which takes care of operations relating to creation, access and deletion of resources and other objects of the database. In such embodiments the modification and/or removal of resources may depend on a user identity and/or an application identity.

According to a first aspect of the present invention there is provided a method comprising:
managing a database for storing resources to be usable by entities; said resources comprising one or more fields;
providing at least one resource with a first control data;
using said first control data to determine whether the resource is related to an entity;
wherein if said first control data indicates that the resource is related to said entity, leaving the resource in the database;
the method further comprising using said first control data to determine whether at least one field of said one or more fields of the resource is modifiable by an entity.

In some embodiments the entity means an application, in some other embodiments the entity means a user of a device, and in some further embodiments the entity may mean an application or a user of a device.

According to a second aspect of the present invention there is provided an apparatus comprising:

a processor; and
a memory unit operatively connected to the processor and comprising:
computer code configured to manage a database for storing resources to be usable by entities; said resources comprising one or more fields;
computer code configured to provide at least one resource with a first control data;
computer code configured to use said first control data to determine whether the resource is related to an entity;
computer code configured to leave the resource in the database, if said first control data indicates that the resource is related to said entity; and
computer code configured to use said first control data to determine whether at least one field of said one or more fields of the resource is modifiable by an entity.

According to a third aspect of the present invention there is provided an apparatus comprising:
a resource manager component configured to manage a database for storing resources to be usable by entities; said resources comprising one or more fields; and to provide at least one resource with a first control data;
a control component configured to use said first control data to determine whether the resource is related to an entity;
an updater component configured to leave the resource in the database, if said first control data indicates that the resource is related to said entity; and further configured to use said first control data to determine whether at least one field of said one or more fields of the resource is modifiable by an entity.

According to a fifth aspect of the present invention there is provided an apparatus comprising:
means for managing a database for storing resources to be usable by entities; said resources comprising one or more fields;
means for providing at least one resource with a first control data;
means for using said first control data to determine whether the resource is related to an entity;
means for leaving the resource in the database, if said first control data indicates that the resource is related to said entity; and
means for using said first control data to determine whether at least one field of said one or more fields of the resource is modifiable by an entity.

According to a sixth embodiment there is provided a computer readable storage medium stored with code thereon for use by an apparatus, which when executed by a processor, causes the apparatus to perform:
manage a database for storing resources to be usable by entities; said resources comprising one or more fields;
provide at least one resource with a first control data;
use said first control data to determine whether the resource is related to an entity;
leave the resource in the database, if said first control data indicates that the resource is related to said entity; and
use said first control data to determine whether at least one field of said one or more fields of the resource is modifiable by an entity.

According to a seventh embodiment there is provided at least one processor and at least one memory, said at least one memory stored with code thereon, which when executed by said at least one processor, causes an apparatus to perform:
manage a database for storing resources to be usable by entities; said resources comprising one or more fields;
provide at least one resource with a first control data;
use said first control data to determine whether the resource is related to an entity;
leave the resource in the database, if said first control data indicates that the resource is related to said entity;
use said first control data to determine whether at least one field of said one or more fields of the resource is modifiable by an entity.

The resource deletion algorithm according to some example embodiments of the present invention may resemble garbage collection algorithms that are used in managed languages, such as Java. The present invention is different from these garbage collection algorithms in several ways. For example, managed language garbage collectors are based on finding objects in memory that are not referenced by other live objects. In RDF database every resource can be referenced, so following references cannot be used as a means to find “garbage” resources. In some example methods according to the present invention the deletion algorithm does not follow any references in the RDF graph but uses the “Last modified by” and “Primary” fields in determining the objects which can be deleted. In an example embodiment the garbage collection algorithm is triggered by uninstallation of an application. It does not happen dynamically during runtime when memory is getting low like in managed languages. The aim is to keep the database in consistent state and preserve storage memory in the process.

In some existing methods it is often assumed that applications accessing the database DB know each other and are able to interoperate in common database. This may be true in a closed system, but not in a system where applications are constantly added and removed. The present invention does not require that applications know each other. Furthermore, some existing methods sometimes assume that the data sets of different applications do not overlap. In this hypothetical case, e.g. each application only handles certain type of data in the common database DB. In this case the problem solved by this invention does not exist. However, the central idea in the semantic desktop is that the data is shared and common, so having distinct data sets is a special situation that cannot be guaranteed in general case when using common database DB. Some existing methods, such as Aperture, do not support removal of data from the database DB with the application. They rely on the application to find out possible data that needs to be removed.

The present invention makes it possible that application interworking is allowed when using common ontology and common database DB, applications' dependencies on each other may also be minimized and applications no longer need to know details about how the other applications handle resources in the database DB. The present invention ma also enable to keep the database DB in consistent state and to preserve storage memory by removing unnecessary resources. The robustness of the database DB may also be improved, if there are applications that intentionally or accidentally add “garbage” resources to the database DB. When the amount of (even 3rd party) applications using the common database increases, robustness may become increasingly important.

### DESCRIPTION OF THE DRAWINGS

In the following the present invention will be described in more detail with reference to the appended drawings, in which

FIG. 1 depicts an example of a resource description framework in which a resource having unique IRI, type and predicates, refers to another resource;

FIG. 2 depicts an example in which two applications A and B use a common ontology and a common database;

FIG. 3 illustrates a problem with data consistency when application A is removed;

FIG. 4 illustrates ownership of resource description framework resources determined by creation and modification;

FIG. 5 illustrates an example situation in which a predicate originally created by the application A is not removed although the application A is removed, because the application B has modified it last;

FIG. 6 depicts an example embodiment of a resource manager component comprising application programming interface, a control, an updater and collector components;

FIG. 7a depicts as a flow diagram an example of creation of a resource;

FIG. 7b depicts as a flow diagram an example of modification of a resource;

FIG. 7c depicts as a flow diagram an example of removal of an application;

FIG. 8 depicts an example of a structure of a resource according to an embodiment of the present invention;

FIG. 9 depicts an example embodiment of some functional blocks of an apparatus of the present invention;

FIGS. 10 and 10b depict an example of an electronic device in which the present invention can be implemented; and

FIG. 11 depicts an example of a system in which the present invention can be implemented.

### DETAILED DESCRIPTION OF SOME EXAMPLE EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

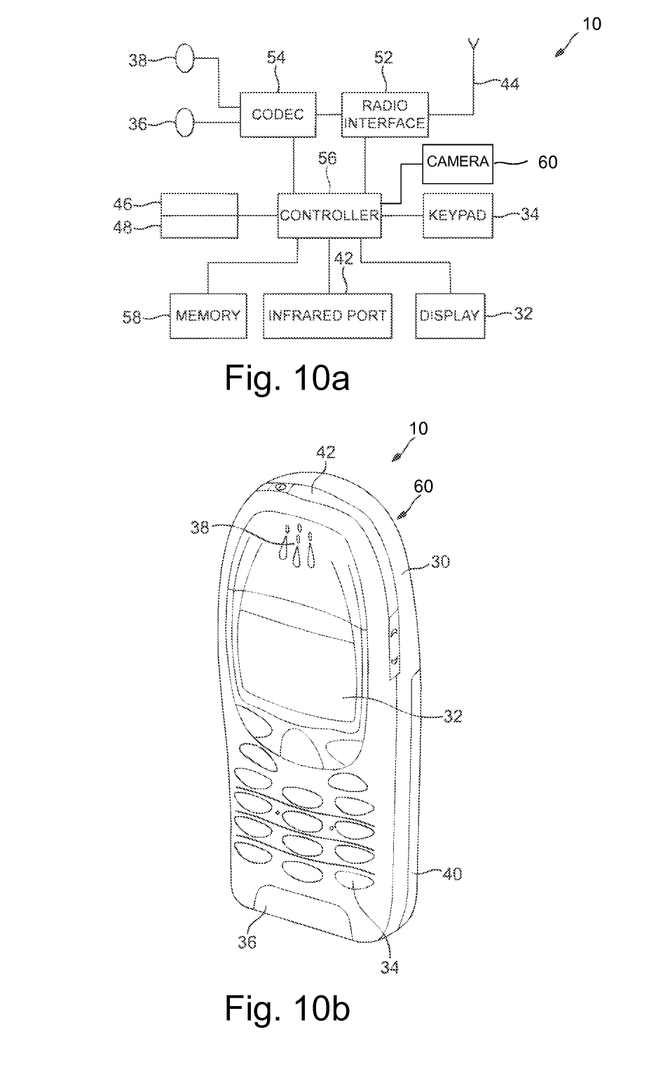

In FIG. 9 an example embodiment of an apparatus 100 according to the present invention is depicted. In this embodiment the apparatus 100, which may be a part of an electronic device 10 depicted in FIG. 10, comprises a processor 102, and a memory 104 which may comprise one or more memory chips, for example. The memory 104 may also comprise memory which may locate on the same chip than the processor 102. The apparatus may also be able to communicate with a user interface of the electronic device 10. The user interface may comprise a display 32, a keypad 34, a microphone 36, an ear-piece 38 and/or a loudspeaker (not shown). The apparatus 10 may also comprise a database interface 108 for exchanging information with a database DB. The database may be an RDF store or another storage of data. The apparatus 100 may further comprise a communication interface 110 for interfacing with a telecommunication block 52 of the electronic device 10.

The memory 104 may comprise, but is not limited to, volatile memory such as a random-access memory (RAM), and non-volatile memory such as read-only memory (ROM), erasable read-only memory, non-volatile RAM (NVRAM), etc. The memory may also comprise a fixed disk, a memory stick or other memory capable of storing large amount of information, even several gigabytes or tens of gigabytes of data.

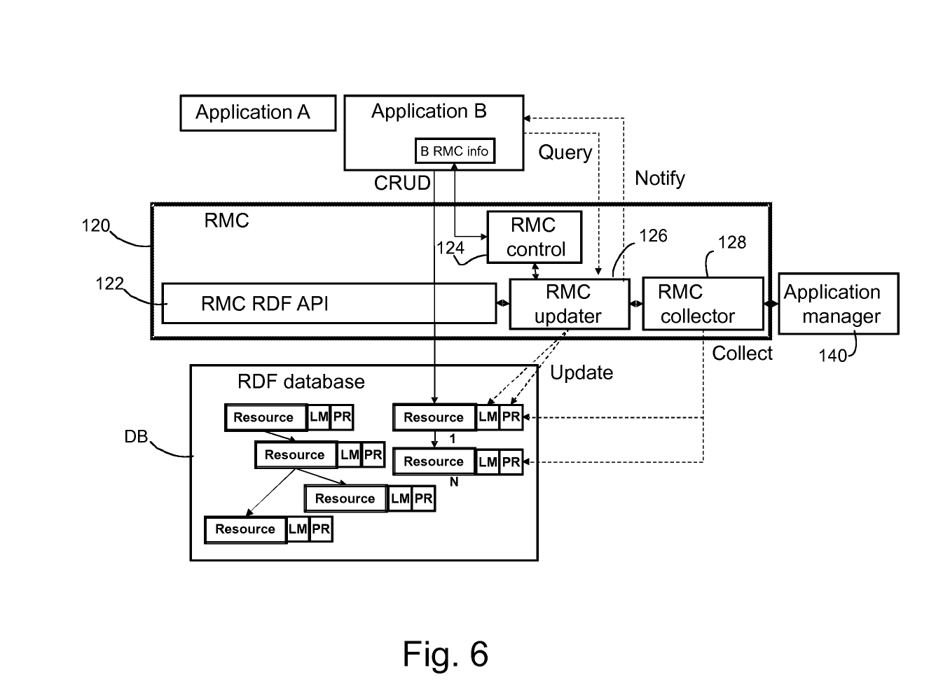

FIG. 6 depicts an example embodiment of some functional blocks according to some example embodiments of the present invention. These functional blocks may be implemented as a program code of the processor 102 wherein the program code enables the processor in association with possible other hardware components, such as the memory 104, to produce the operations of the functional blocks. In the following the details of the hardware will not be discussed but the operations which the functional blocks are intended to produce.

The functional blocks comprise a resource manager component (RMC) 120 which contains an RDF application programming interface (API) 122, a control component 124, an updater component 126 and collector component 128. The resource manager component 120 also has an application manager interface 130 for communicating with an application manager 140. The application manager 140 may be a part of the operating system of the apparatus 100. The operating system may be, but is not limited to, Maemo™, Symbian™, Android™, Windows™ or BREW™ operating system. The operating system takes care inter alia of scheduling the execution of different processes run by the processor 106 of the apparatus.

The resource manager component 120 may be added to the platform RDF database interface that is used by the applications. The components of the resource manager component 120 may provide the following functionalities.

RDF Application Programming Interface

One role of the RDF application programming interface 122 is to identify the application that is performing a database operation. The database operation and the target resource(s) may also be observed, too. This information is supplied to and used by the updater component 126. If the RDF application programming interface 122 is integrated inside the RDF database implementation, applications can continue to use the RDF database application programming interfaces like before and application identification is transparent for the application.

Control

An application may provide information about its “primary” predicates for each resource type it is planning to create or use. This information determines how “primary” predicates are set. “Last modified by” fields can be maintained automatically without any configuration from applications. An application may also provide other configuration information that affects how resources are handled, which will be described later in this application. All information can be provided e.g. in a form of XML declaration file when the application is installed. This allows applications not to perform any API calls to RMC during runtime, unless they wish to query resource ownership details. The control component 124 is able to read the application RMC info and provide it to the updater component 126.

Update

Updater component 126 maintains “Last modified by” and “Primary” fields for each predicate in each resource based on information from control component 124 and the RDF application programming interface 122. The updater component 126 also maintains a list of applications that have written to the RDF database. In a case where a predicate value that has been defined primary for application(s) is getting modified, the updater component 126 notifies all the applications that have this predicate as primary and have registered for notification. Such applications can then decide whether further actions are necessary. The updater component 126 also allows applications to query the status of the resource's “Last modified by” and “Primary” fields for each predicate, if needed. This allows applications to change their behaviour, if they detect that some other application is also using a resource they are about to modify.

Collect

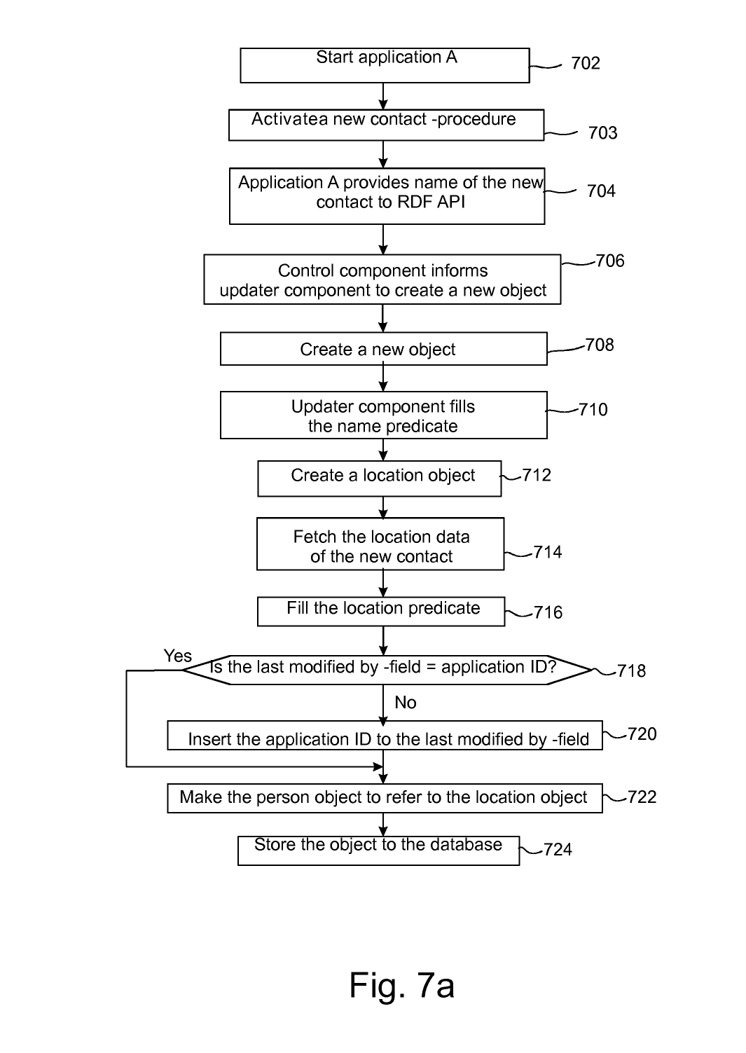

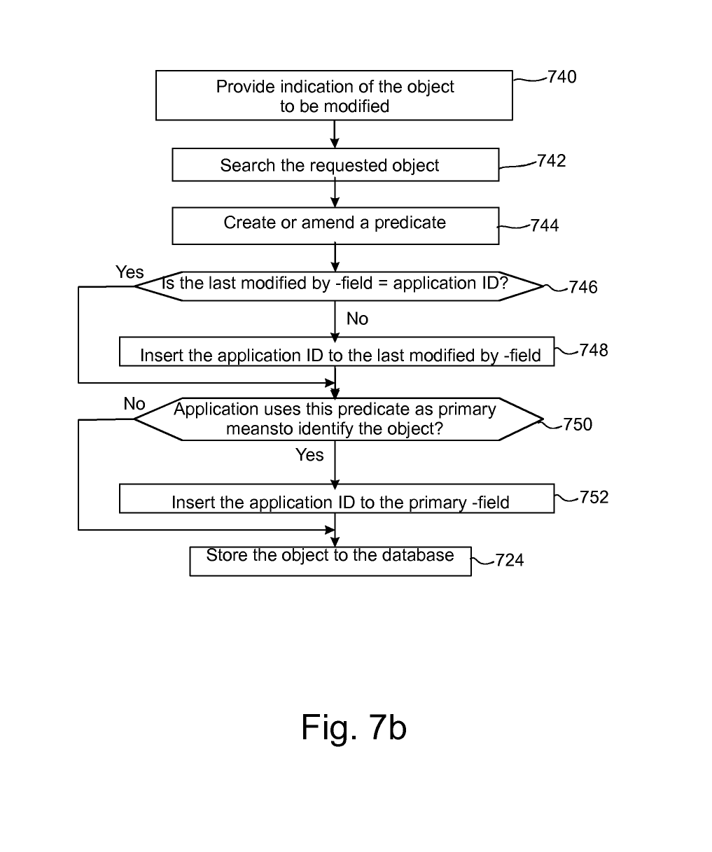

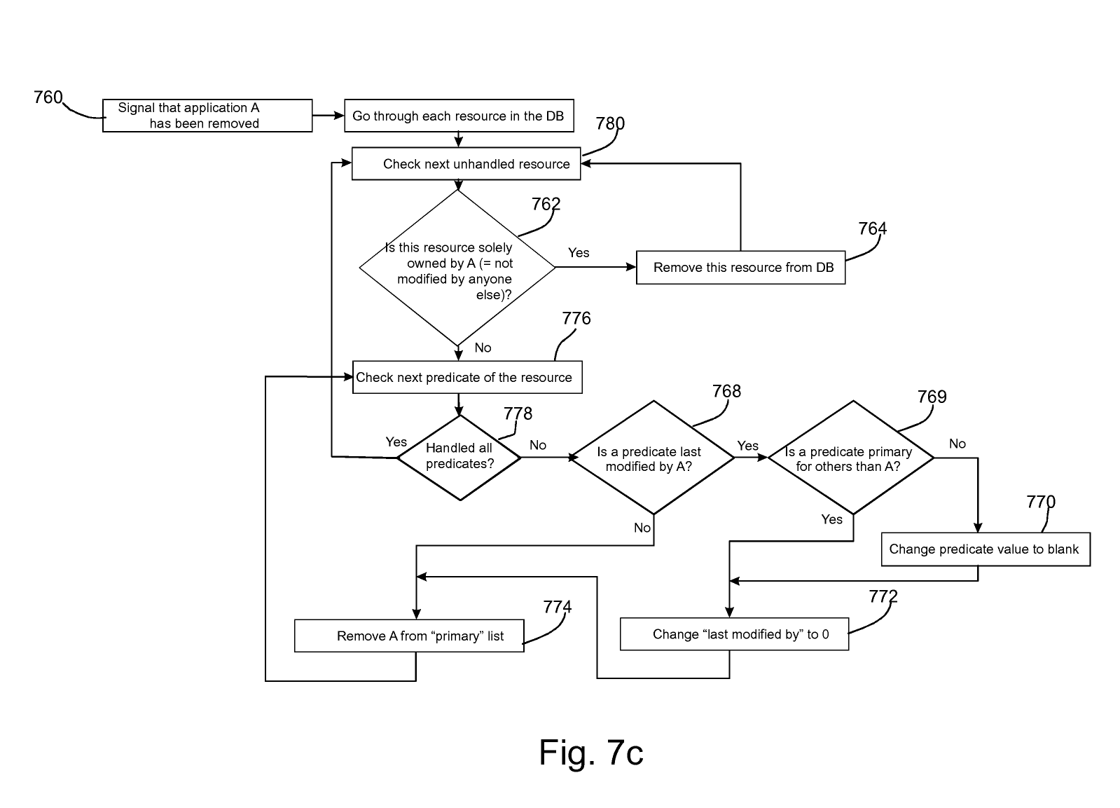

The collector component 128 is activated when it receives notification that data related to a certain application can be removed. This notification may be received from the application manager 140 when an application has been uninstalled. If an application has written to the RDF database, the collector component 128 checks all resources in the database and removes unused resources using e.g. the algorithm described in FIG. 7c. The collector component 128 also updates “Last modified by” and “Primary” fields for each predicate in the process. The collector component 128 may also set some predicate values to blank, NULL or another appropriate value.

Applications may perform create, read, update and delete (CRUD) operations on resources. The updater component 126 may maintain “Last modified by” and “Primary” fields as follows.

When a resource is created, a “Creator” field of the resource is set to include the ID of the creating application, and the “Last modified by” field for each predicate is also set to include the ID of the creating application. If the application has not provided any other indication about the primary predicates, the “Primary” field for each predicate is also set to include the ID of the creating application ID.

When a resource is read, no changes to the “Last modified by” and “Primary” fields are made.

When a resource is updated by changing values of some predicate(s), the following operations may be performed. The “Last modified by” field for the updated predicate is set to the ID of the updating application. The “Primary” field for each primary predicate is set to the ID of the updating application. In a situation in which updating relates to a predicate that has different “Primary” applications than this updating application, all the applications may be notified that the value of their primary predicate is about to change. The notification includes the resource IRI and the name of the predicate.

When a resource is updated by changing the type of the resource, the “Last modified by” and “Primary” fields are created for each new predicate.

When a resource is deleted, all RMC fields are deleted with the resource.

In an example implementation, the “Creator”, “Last modified by” and “Primary” fields are stored in the same database that holds the resources. The fields can be stored as predicates of a resource. The “Last modified by” and “Primary” fields store data for each predicate in the resource, which means storing data about multiple predicates encoded into a single field. Hence, the “Last modified by” and “Primary” fields are easy to keep in sync with the actual resource.

In another example implementation, the “Last modified by” and “Primary” fields are stored in a separate binary file which is managed by the resource manager component 120. The file format (here in clear text) can be e.g.

| | |
|---|---|
| Resource <resource identifier> | <creator> |

| Predicate 1 | <LM> <PR> |
|---|---|
| ... | |
| Predicate N | <LM> <PR> |

The fields may need to be quickly accessible when reading the database DB based on the resource identifier. Also vice versa: it may be necessary to be fast to get data from fields to the database DB. RDF resource IRI can be used as a resource identifier, but an example implementation might use an internal database resource pointer that is used by many database implementations. The resource manager component 120 maintains fields data and does necessary cleaning when a resource is deleted from the database DB.

In some embodiments the “Creator”, “Last modified by” and “Primary” fields list pointers to correct application structures, instead of listing application names or IDs. This makes it possible that each entry in the field is of a certain length, for example 32 bits. Therefore, such implementation may take less memory than if the application name were stored instead. In some other embodiments the “Creator”, “Last modified by” and “Primary” field can point to an application index, which can be e.g. 8-bit, if there are less than 256 applications using the database DB. The size of the additional bookkeeping may have some significance, as the bookkeeping needs to be done for every resource in the database DB. In an example implementation “Last modified by” and “Primary” fields are not stored for those resources that are created and used by only a single application but only an index to the creating application is stored when a resource is created. This effectively means that every predicate “Last modified by” and “Primary” field may have the creating application as a default value. This may reduce the overhead considerably, as most resources are modified only by one application. In such a case, the file format (here in clear text) can be e.g.

Resource <resource identifier> <creator, 8-bit application index>

As the “Creator” field is per resource, it can also be rather efficiently stored as a resource predicate in the database DB. In this case, the file managed by the resource manager component 120 would only be used for those resources that are used by more than one application.

In an example implementation, applications are able to tell the resource manager component 120 their preferred management policy for resources created by them. For example, an application may specify the following kinds of rules:
Certain type of resources created by an application will never be removed;
Certain predicate values inside a resource must not be modified by other applications.

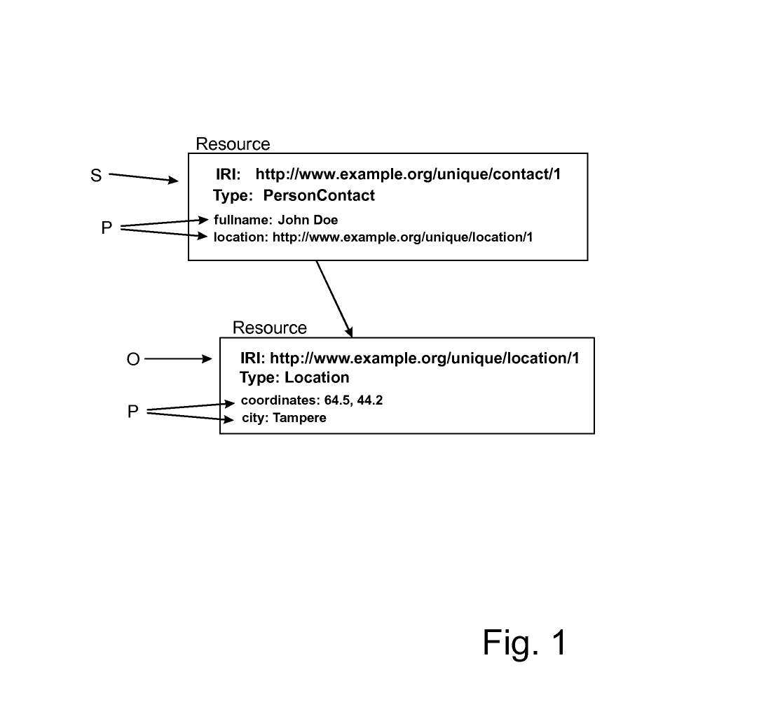

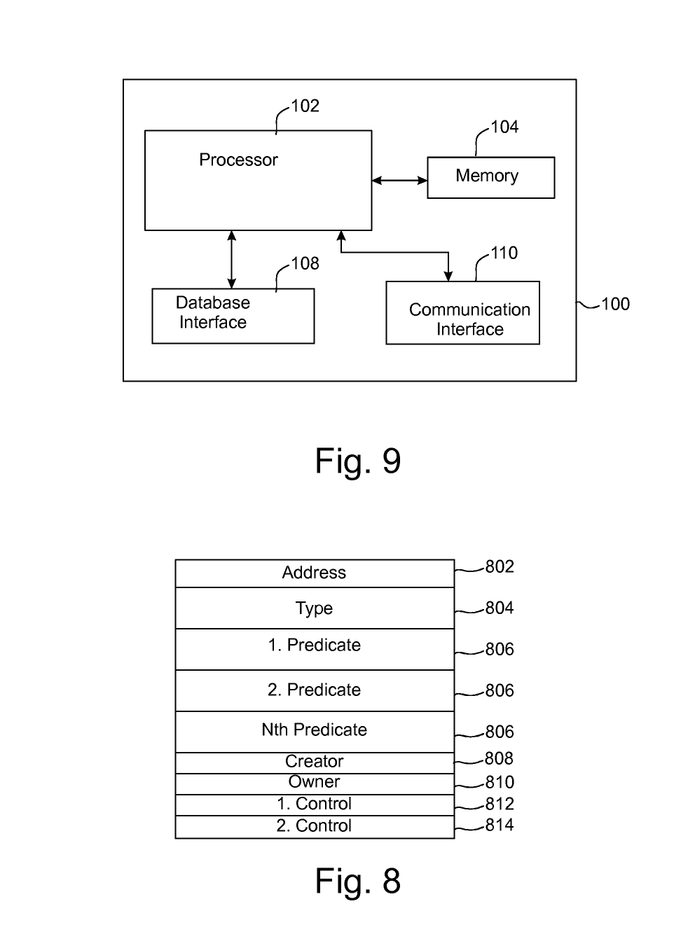

In the following an example of the structure of resources according to an embodiment of the present invention will be described in more detail with reference to FIG. 8. The structure 800 comprises an address field 802 in which the address of the resource can be stored. The address may be e.g. an address according to the unique internationalized resource identifier definition. There is also a type field 804 which indicates the type of the resource. Some examples of types of resources are person contact and location but also other types are possible. The structure also comprises one or more predicates 806 which may depend on the type of the structure. For example, in the resource having the type “person contact” one predicate may include the full name of the person, another predicate may include the address of the person, yet another predicate(s) may include the phone number(s) of the person, etc. In the resource having the type “location” one predicate may include the coordinates of the location of the person, another predicate may include the name of the city corresponding to the location, etc. It should be noted here that one or more of the predicates of the resource may include a reference to another resource. The reference is, for example, an address of the referred resource. An example of such situation is predicted in FIG. 1 in which the person contact resource contains the address of the location resource. The resource also comprises a creator field 808 for storing an indication of the application which created the resource, as was described above. The resource may further comprise an owner field 810 for storing an indication of applications that have modified the resource.

The owner field 810 may also be called as a first control data.

It should be mentioned here that resources may also comprise other fields in addition to the fields mentioned above, and there may be different predicates from those mentioned above.

The value of the creator field 808 may not change during the resource lifetime and it may merely be used to optimize the implementation.

The list of “owner” applications of a particular resource is the union of the “Last modified by” fields of all predicates. The owners of a resource can be derived from these during runtime and do not need to be stored.

In some example embodiments of the present invention the following fields are defined for each predicate in a resource:
A first control field 812, which may also be called as Last modified by -field (LM). This field indicates which application modified the value of this predicate last. This field may be updated every time the predicate value is changed, if the value for the field is different than the ID of the updating application. If not set, the default value for the LM field is the value of the “Creator” field.
A second control field 814, which may also be called as Primary -field (PR). This field contains indication of applications that uses this predicate as a primary means to identify this resource. In other words, applications indicated by the primary field should be notified, if this predicate value is changed. In an example embodiment, the primary field is only updated when an application either creates a resource or starts to use a resource created by some other application for the first time. The second control field 814 may contain multiple values.

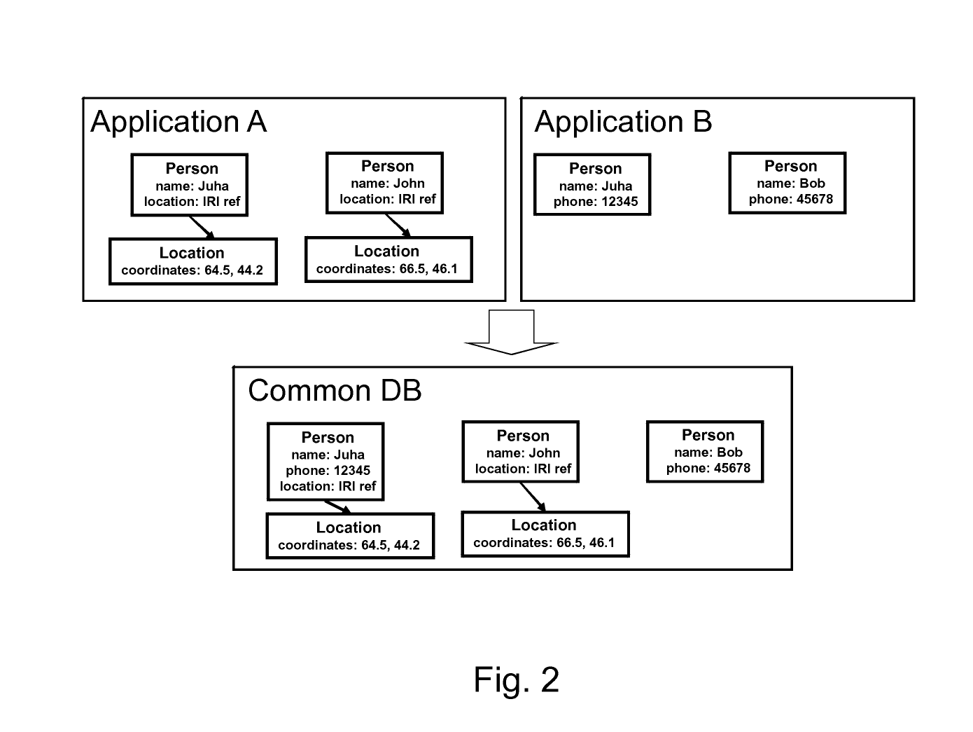

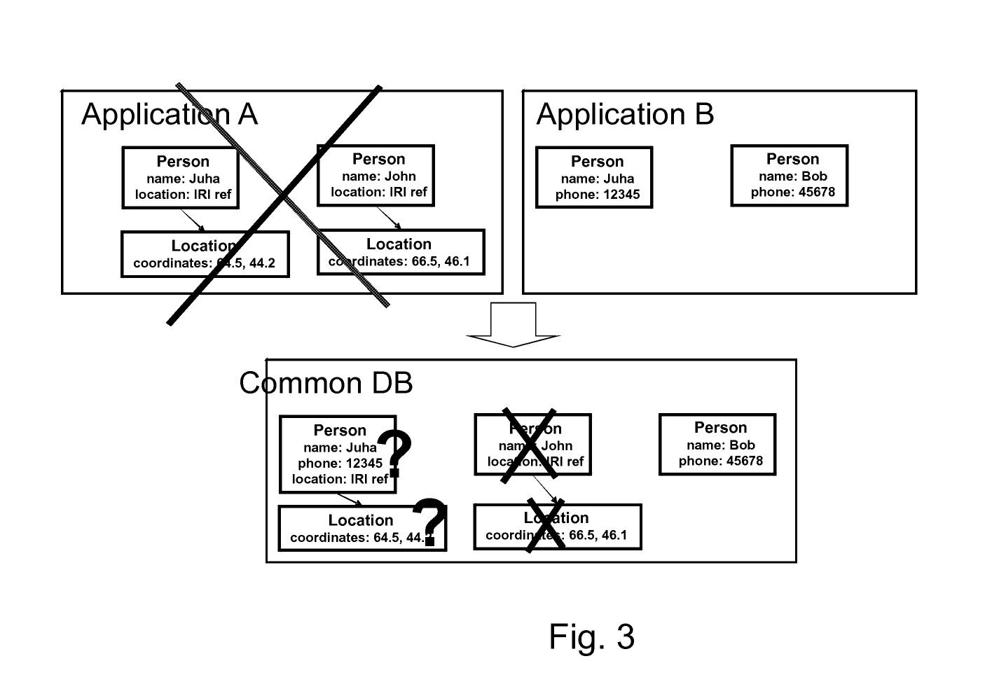

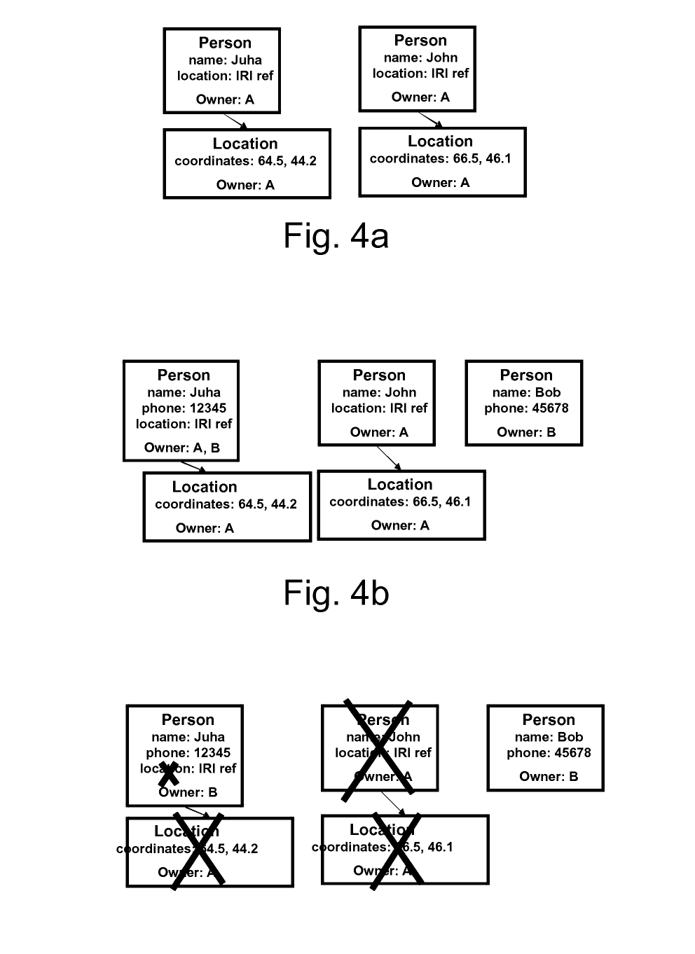

For example, bookkeeping for a Person object in the common database DB in FIG. 2 may include:

TABLE 1
Resource creator A
Resource owners LMname U
LMphone U
LMlocation = {A, B}

| | | Last modified by | Primary (list of |
|---|---|---|---|
| | | (single app/ | apps/predicate), |
| Predicate name | Predicate value | predicate), LM | PR |
| name | Juha | A | A, B |
| phone | 12345 | B | 0 |
| location | IRI ref | A | 0 |

In Table 1 the value 0 denotes that this field is not set. In practical applications this may be indicated in many different ways. For example, such a field may include a NULL value, a zero value, or another value which indicates that the field has not been set to a specific value.

Creating an Object

In the following an example of the creation of a resource will be described in more detail with reference to the flow diagram of FIG. 7a. The application A is started 702 if it is not already running. The operating system of the device 10 may be used to control the execution of applications wherein the operating system may perform the necessary steps to cause the electronic device 10 to start the application A. The operating system may also inform the application manager 140 that the application A has been started. The application A is, for example, a contact application which manages information of contacts of the user of the device 10 i.e. an address book application. In an example situation the user of the device 10 decides to add a new contact to the database DB and uses the user interface of the device 10 to activate 703 a new contact-procedure of the application A. The user inputs the contact data such as the name of the new contact. Then, the application A communicates with the resource manager component 120 to add a new object of the type Person to the database DB. Application A provides 704 information of the name to the application programming interface 122 of the resource manager component, wherein the application A may create or initiate the creation of the resource through the application programming interface 122. The controlling component 124 of the resource manager component informs 706 the updater component 126 of the resource manager component to fill the name predicate of the new object with the name provided by the application A. The application A sets 710 the name predicate to the value the user has indicated i.e. the name of the new contact.

The application A may also initiate a creation 712 of a location object so that the person object points to the location object. The application A may then call another application to fetch 714 the location of the person. The location may be fetched from a network service, such as Google Maps which is a network service created by the Google Inc. company, a Sports Tracker service by Sports Tracker Technologies, etc. When the network service has gathered the location of the user it may send the information to the electronic device 10 in which the information can be provided to the application A so that the application A can fill 716 the location to the location predicate. If the last modified by field already has the value indicative of the application A the last modified by field need not be changed 718. Otherwise, the last modified by -field of the location predicate is inserted 720 with a value which indicates that the application A is the latest modifier of the location predicate. The person object is also included 722 with a reference to the location object. The reference may be e.g. in the form of the unique internationalized resource identifier IRI. The procedure to create the location object and to set the predicate(s) of the location object may be performed in the same way than the creation of the person object. It should be noted here that in practical implementations the communication between applications and the database DB may differ from the above but a skilled person is able to implement the invention in different platforms on the basis of this description.

The object including the predicates which have been defined a value is then stored 724 to the database DB. Other possible predicates which have not been filled in will be left e.g. untouched or filled with an initial value such as NULL or 0.

In some example embodiments several database operations may be queued and then executed them as one batch. Another approach is to execute database operations one-by-one, for example already in creation phase and update when needed.

Modifying an Object

FIG. 7b depicts a situation in which another application such as an application B intends to modify an object which already exists. For example, application B is able to add a phone number to the contacts database. Hence, the user may input the phone number of the already existing contact. The application B communicates with the resource manager component 120 to inform that an object is to be modified. The application B provides 740 indication of the object and possibly the information to be inserted/modified (e.g. the phone number) to the updater component 126 or to the application programming interface 122 which searches 742 the requested object from the database DB. The updater component 126 creates a new predicate or amends 744 an existing predicate of the object according to the information provided by the application B. If the application identifier in the last modified by -field of the predicate differs 746 from the identifier of the application B, the updater component 126 modifies 748 the last modified by -field of the predicate to include the identifier of the application B. Otherwise, the field may be left untouched. The updater component 126 also adds 752 the identifier of the application B to the primary field of the predicate, if the application B uses 750 that predicate as primary means to identify this object.

There may also be other predicates for which the user inputs data and the application A, B or another application provides this information to the RDF application programming interface 122.

Deleting an Object

In FIG. 7c an example of a deletion algorithm for a resource when the application A is removed is shown as a flow diagram. The application manager 140 signals 760 the collector component 128 that the application A has been removed. The collector component 128 examines 762 the owner field of the resources to determine which resources are solely owned by the removed application A. If the resource under examination is solely owned by the application A, the resource is removed 764 from the database DB. Otherwise, one predicate of the resource is examined 768 to determine if that predicate is last modified by the application A (by examining the last modified by -field). If not so, the identifier of the application A is removed 774 from the primary field. Otherwise, i.e. if that predicate is last modified by the application A, a further check 769 is made to determine whether that predicate is a primary predicate for other applications than the application A (by examining the primary -field). If so, the last modified by -field is set 772 to 0 and the identifier of the application A is removed 774 from the primary field. Otherwise, the value of the predicate is set 770 to blank the last modified by -field is set 772 to 0, and the identifier of the application A is removed 774 from the primary field. Then, another predicate of the resource will be examined 776 correspondingly until all predicates have been handled 778. The procedure may then continue by examining 780 whether there still are unexamined resources. If so, the examination may continue from block 762 until all resources to be examined have been handled. The modification and removal of the resource/predicates may be performed by the collector component 128 or the collector component 128 may inform the updater component 126 which resources or predicates shall be removed or modified.

In an example implementation, the collector component 128 runs soon after when an application is removed. The run may last several seconds and may take considerable amount of CPU resources of the device 10. However, in another implementation the collector component 128 may be run when the device 10 is in an idle state and not interacting with the user. Cleaning the database immediately is not required by other applications so collecting unused resources can be scheduled to take place at a convenient time.

According to an example embodiment the end result after the deletion may look like this:

Resource creator A
Resource owners LMname U
LMphone U
LMlocation = {B}

| | | Last modified by | Primary (multiple |
|---|---|---|---|
| Predicate name | Predicate value | (single value), LM | values), PR |
| name | Juha | 0 | B |
| phone | 12345 | B | 0 |
| location | <blank> | 0 | 0 |

The invention allows applications to query “Last modified by” and “Primary” fields for a resource. This allows applications to change their behaviour, if they detect that some other application is also using a resource they are about to modify. The invention also provides a callback for applications that wish to be notified when their “Primary” predicate in a resource is being modified by some other application.

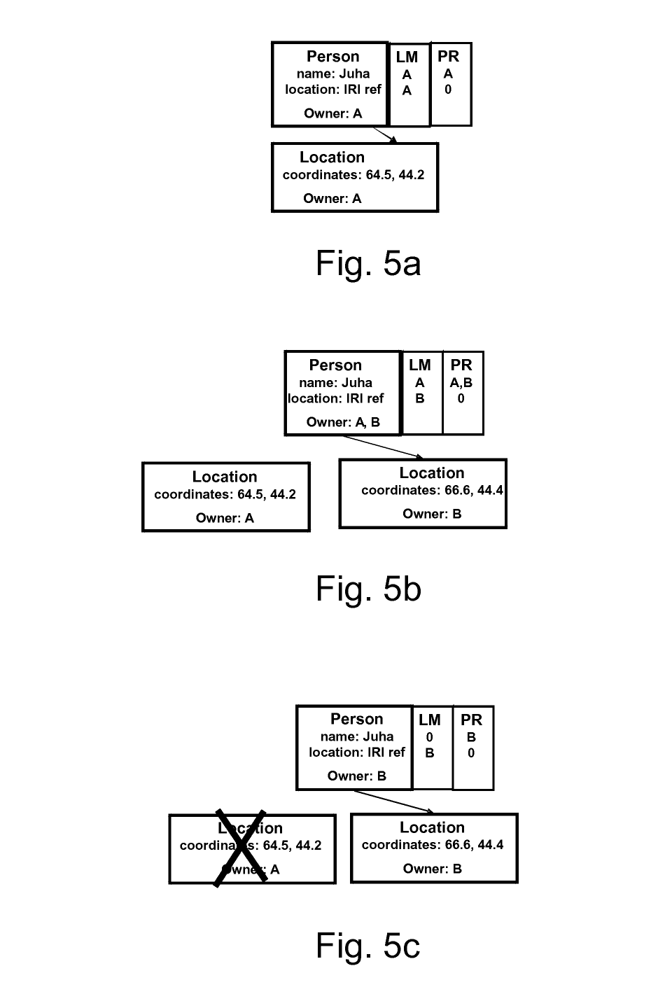

FIGS. 5a-5c illustrate an example situation in which a predicate originally created by the application A (FIG. 5a) is not removed although the application A is removed (FIG. 5c), because the application B has modified it last (FIG. 5b).

In the above described example the deletion of an object was initiated when an application has been removed. However, there may also exist other situations in which there is a need to delete objects. For example, the user may wish to delete resources which have been created by her/him regardless of the application which was used when the resource was created. Hence, one or more of the control fields may be used to store identification information of the user (e.g. a user id). Hence, information on all such resources in which the user id in a certain control field corresponds to the user's id could be collected e.g. by the collector component 128 and this collected information could then be used by the updater component 126 to remove those resources.

In yet another embodiment the collector component 126 may provide the collected information of resources to the user interface (e.g. via the operating system) wherein the collected information on resources may be displayed to the user. The user may then select one or more of those resources for removal. Hence, the user has the possibility to select a partial removal of resources.

In some other embodiments the database may be located in a network server or another device accessible via a network such as the internet. The database may be accessible by multiple devices wherein a controlled management of the database is desired. Resources created by applications may then also include an identification regarding the device and/or the user of the device as a part of the first or second control field or they may be provided as a third control field. That information may then be used to determine resources created by a certain user and/or a certain application of the user's device. Those resources may then be collectively removed if the user so desires by using the deletion operations described above. Also when the user modifies a resource in the database the user's id may be added to e.g. the first control field of the resource to indicate that the resource has been (last) modified by the user.

In still some embodiments the database may be located in one user's device and other devices of possibly other users may be able to obtain access to the database e.g. via a short range communication connection such as Bluetooth™, via a mobile communication network, etc. In such embodiments the resources are provided with information of the user or the device which created or modified a resource or a predicate of the resource using similar operations than described above. For example, a first user may have sent some information to a database stored in a second user's device, wherein that information may be accessible to applications in the second user's device or even applications in a third user's device. By utilizing the principles of the present invention the first user may initiate operations if he/she so wishes to remove from the database in the second user's device all the resources in which the first user's information have been stored.

The present invention enables controlled management of databases which include recourses so that not only the application and/or user who created the resource but also other applications and/or users may modify the resources and insert new predicates to the resources, unless optional rules have been defined for the recourses to prevent user's operations to resources created by others.

In embodiments in which both the user identifier and the application identifier are used they can be inserted in different control fields, or in the same control field wherein some kind of masking operation may be needed to differentiate the user and the application. For example, if all resources created by a certain user are to be deleted, the masking operation disregards the application identifier and only uses the user identifier.

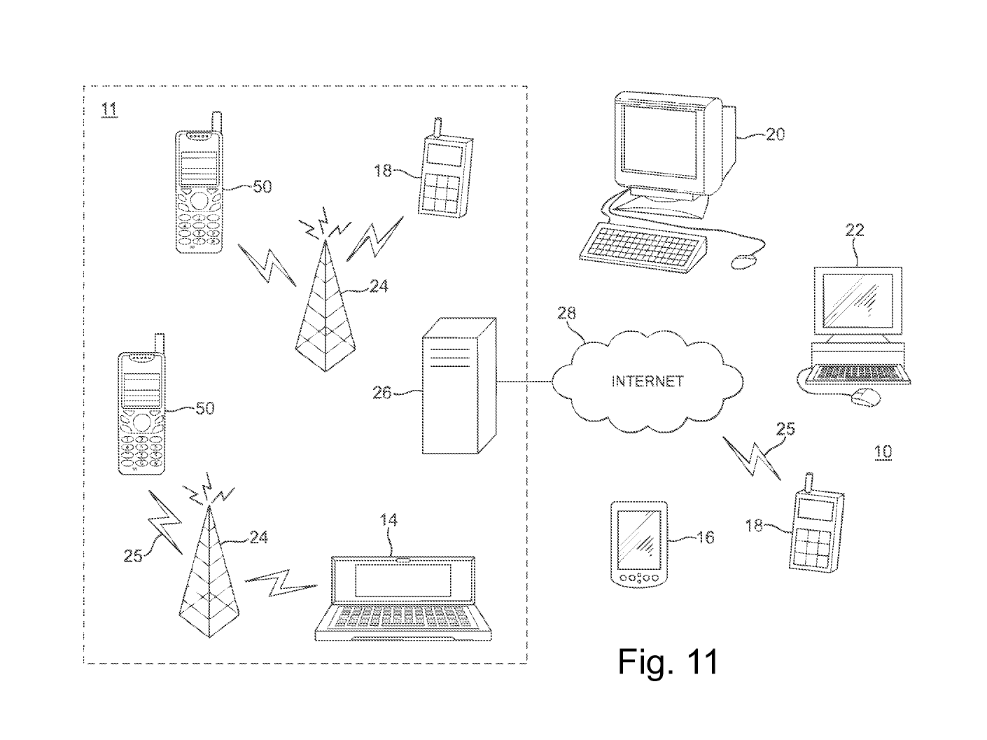

FIG. 11 illustrates a system in which the apparatus 100 according to the present invention may be used. The exemplary communication device comprising the apparatus 100 may include, but is not limited to, an electronic device 10 in the form of a mobile telephone 50, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

FIGS. 10a and 10b show one representative electronic device 10 which may be used as or include an apparatus in accordance to the various embodiments of the present invention. It should be understood, however, that the scope of the present invention is not intended to be limited to one particular type of device. The electronic device 10 of FIGS. 10a and 10b includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The electronic device 10 may also include a camera 60. The above described components enable the electronic device 10 to send/receive various messages to/from other devices that may reside on a network. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1. A method comprising:
managing a database for storing resources to be usable by entities; said resources comprising one or more fields;
providing at least one resource with a first control data;
using said first control data to determine whether the resource is related to an entity;
wherein if said first control data indicates that the resource is related to said entity, leaving the resource in the database;
the method further comprising using said first control data to determine, with a processor, whether at least one field of said one or more fields of the resource is modifiable by an entity.

2. The method according to claim 1, wherein if said first control data indicates that the resource is not related to any entity, the method further comprises enabling removing the resource from the database.

3. The method according to claim 1, wherein said entity is an application.

4. The method according to claim 3, comprising providing an application identifier for said application; and providing said application identifier in said first control data.

5. The method according to claim 4, said managing a database comprising removing a resource from said database, wherein said method further comprises:
receiving information of removal of said application;
examining said first control data of the resource to determine whether the first control data contains an identifier corresponding to another application;
if not so, initiating a removal of said resource;
otherwise examining a second control data relating to a field of said resource to determine whether the second control data contains an identifier corresponding to said application identifier;
if not so, removing the application identifier from a third control data of said field of said resource;
otherwise examining said third control data to determine whether said field is used by another application as a primary means to identify the resource;
if so, setting the second control data to a first predetermined value and removing the application identifier from said third control data of said field of said resource;
otherwise setting the third control data to a second predetermined value, setting the second control data to a first predetermined value and removing the application identifier from said third control data of said field of said resource.

6. The method according to claim 4, said managing a database comprising modifying a field of a resource in said database, wherein said method further comprises:
receiving information of the resource to be modified;
searching said resource from the database;
modifying said field;
examining a second control data relating to said field of said resource to determine whether the second control data contains an identifier corresponding to said application identifier;
if not so, including the application identifier to said second control data of said field of said resource; and
including the application identifier to a third control data of said field of said resource.

7. The method according to claim 4, said managing a database comprising creating of a resource to said database, wherein said method further comprises:
receiving information of the resource to be created;
inserting said resource to the database;
inserting said application identifier to said first control data; and
examining a second control data relating to said field of said resource to determine whether the second control data contains an identifier corresponding to said application identifier;
if not so, including the application identifier to said second control data of said field of said resource.

8. The method according to claim 1, wherein said entity is a user of a device.

9. The method according to claim 8, comprising providing a user identifier for said user; and providing said user identifier in said first control data.

10. The method according to claim 8, wherein a field of the resource is provided with a second control data or a third control data, wherein the method further comprises providing said user identifier in said second or third control data.

11. The method according to claim 9, said managing a database comprising removing a resource from said database, wherein said method further comprises:
receiving information of removal of said resource;
examining said first control data of the resource to determine whether the first control data contains an identifier corresponding to said user identifier;
if so, initiating a removal of said resource.

12. The method according to claim 1 further comprising defining at least one rule for said resource, said rule being indicative of a permission to modify or delete said resource.

13. The method according to claim 5 comprising using a last modified by field as said second control data.

14. The method according to claim 5 comprising using a primary field as said third control data.

15. The method according to claim 1 comprising using an owner field as said first control data.

16. (canceled)

17. The apparatus according to claim 64, wherein the apparatus is further caused to enable removing the resource from the database, if said first control data indicates that the resource is not related to any entity.

18-26. (canceled)

27. The apparatus according to claim 64, wherein the apparatus is further caused to define at least one rule for said resource, said rule being indicative of a permission to modify or delete said resource.

28-62. (canceled)

63. A computer readable storage medium stored with code thereon for use by an apparatus, which when executed by a processor, causes the apparatus to perform:
manage a database for storing resources to be usable by entities; said resources comprising one or more fields;
provide at least one resource with a first control data;
use said first control data to determine whether the resource is related to an entity;
leave the resource in the database, if said first control data indicates that the resource is related to said entity; and
use said first control data to determine whether at least one field of said one or more fields of the resource is modifiable by an entity.

64. An apparatus comprising at least one processor and at least one memory, said at least one memory stored with code thereon, which when executed by said at least one processor, causes the apparatus to perform:
manage a database for storing resources to be usable by entities; said resources comprising one or more fields;
provide at least one resource with a first control data;
use said first control data to determine whether the resource is related to an entity;
leave the resource in the database, if said first control data indicates that the resource is related to said entity;
use said first control data to determine whether at least one field of said one or more fields of the resource is modifiable by an entity.

65. The apparatus according to claim 64, wherein the apparatus is further caused to enable removing the resource from the database, if said first control data indicates that the resource is not related to any entity.
